(19) United States
(12) Patent Application Publication
(10) Pub. No.: US 2007/0138810 A1
(43) Pub. Date: Jun. 21, 2007

(54) Door latch for motorhome/travel trailer

(76) Inventor: Paul Armbrustmacher, Laingsburg, MI (US)

Correspondence Address: HARNESS, DICKEY & PIERCE, P.L.C., P.O. BOX 828, BLOOMFIELD HILLS, MI, 48303, US

(21) Appl. No.: 11/295,800

(22) Filed: Dec. 7, 2005

(51) Int. Cl. E05B 3/00

(52) U.S. Cl. 292/336.3

(57) ABSTRACT

A motorhome/travel trailer has a door with a latch actuation assembly. The door latch actuation assembly includes a latch actuation member slidably coupled to the door. The latch actuation member has first and second portions. The first portion is disposed on an interior portion of the door. The first portion includes an internal actuation portion. The second portion includes an engagement portion. The engagement portion is configured to actuate an external actuation member.

### FIELD OF THE INVENTION

The present teachings relate to door latches and more specifically to door latches for motorhomes/travel trailers.

### BACKGROUND OF THE INVENTION

Motorhomes/travel trailers generally include outer screen doors having an exterior mounted handle to open and close the door. The doors usually include a slidable member mounted on the door proximate the exterior mounted handle to enable access to the handle from within the motorhome/travel trailer. Typically, the portion of the door proximate the exterior mounted handle, covered by a slidable member, is not covered by any screen in order to allow actuation of the exterior mounted handle from within the motorhome/travel trailer. Opening of the sliding member to actuate the exterior mounted handle can be both burdensome and undesirable. Opening this non-screened passage can allow things such as insects to enter the motorhome/travel trailer. Therefore, it is desirable to be able to open a motorhome/travel trailerscreen door without exposure of an unobstructed passage.

### SUMMARY OF THE INVENTION

A motorhome/travel trailer includes a door with a latch actuation assembly. The door latch actuation assembly includes a latch actuation member slidably coupled to the door. The latch actuation member includes first and second portions. The first portion is disposed on an interior portion of the door. The first portion includes an internal actuation portion. The second portion includes an engagement portion. The engagement portion is configured to actuate an external actuation member.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present teaching will become more fully understood from the detailed description and the accompanying drawings, wherein:

FIG. 1 is a side view of a motorhome/travel trailer having a door including the latch actuation assembly of the present disclosure;

FIG. 2 is an outside view of a portion of the door shown in FIG. 1;

FIG. 3 is an inside view of a portion of the door shown in FIG. 1;

FIG. 4 is an outside view of a portion of the door shown in FIG. 1 with the housing moved to an open position;

FIG. 5 is an outside view of a portion of the door shown in FIG. 1 with the latch actuation member in an engaged position;

FIG. 6 is a perspective view of the housing and door latch actuation assembly shown in FIG. 1;

FIG. 7 is an additional perspective view of the housing and door latch actuation assembly of FIG. 1; and

FIG. 8 is an exploded view of the housing and door latch actuation assembly shown in FIG. 7.

### DETAILED DESCRIPTION OF THE PREFERRED EMBODIMENTS

The following description is merely exemplary in nature and is in no way intended to limit the disclosure, its application, or uses.

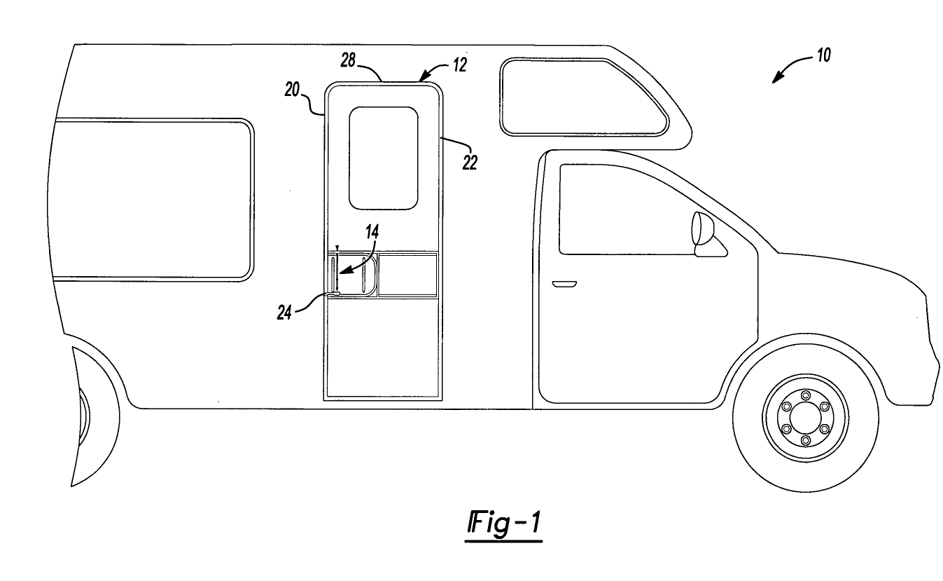

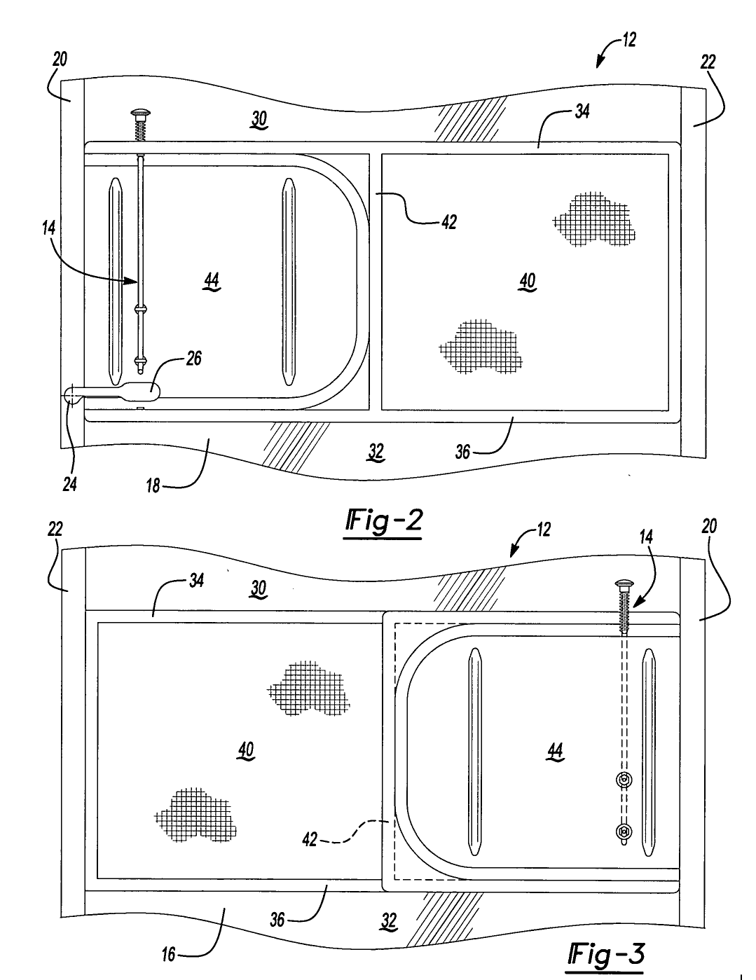

With reference to FIG. 1 a motorhome/travel trailer 10 is shown with a door 12 which includes a door latch actuation assembly 14 according to the teachings of the present disclosure. With additional reference to FIGS. 2-5, the door 12 includes a substantially rectangular body having interior and exterior portions 16, 18 and includes first and second edges 20, 22. The first edge 20 is generally free to rotate relative to the motorhome/travel trailer 10 and the second edge 22 is generally pivotally coupled to the motorhome/travel trailer 10. An external actuation member in the form of a handle 24 is rotatably mounted to the exterior portion 18 of the door 12 proximate the first edge 20. The handle 24 includes a radially extending portion 26 for rotational actuation of the handle 24 to actuate a door latch (not shown), thereby enabling the door 12 to be opened and closed.

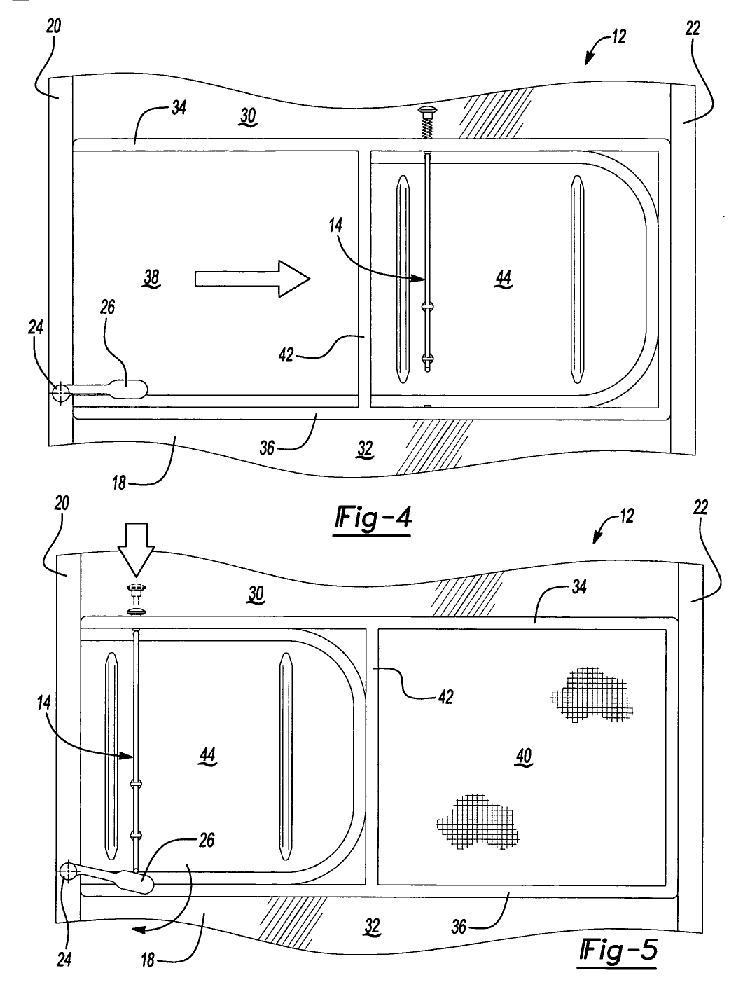

The body of the door 12 includes an outer frame portion 28 with an upper screen 30 and a lower screen 32. A center region is defined by a series of horizontally disposed tracks 34, 36 which extend across the frame portion 28 generally from first edge 20 to second edge 22 between the upper and lower screens 30, 32. The center region is further separated into two sections 38, 40 by a vertically extending member 42. The first center section 38 is proximate the first edge 20 of the door 12 and includes a generally rectangular open area with no screen disposed therein (as seen in FIG. 4). The second center section 40 is proximate the second edge 22 and has a generally rectangular screened area (as seen in FIGS. 2 and 3). A housing 44 is slidably coupled to the tracks 34, 36 to selectively close and open the first center section 38 of the door 12.

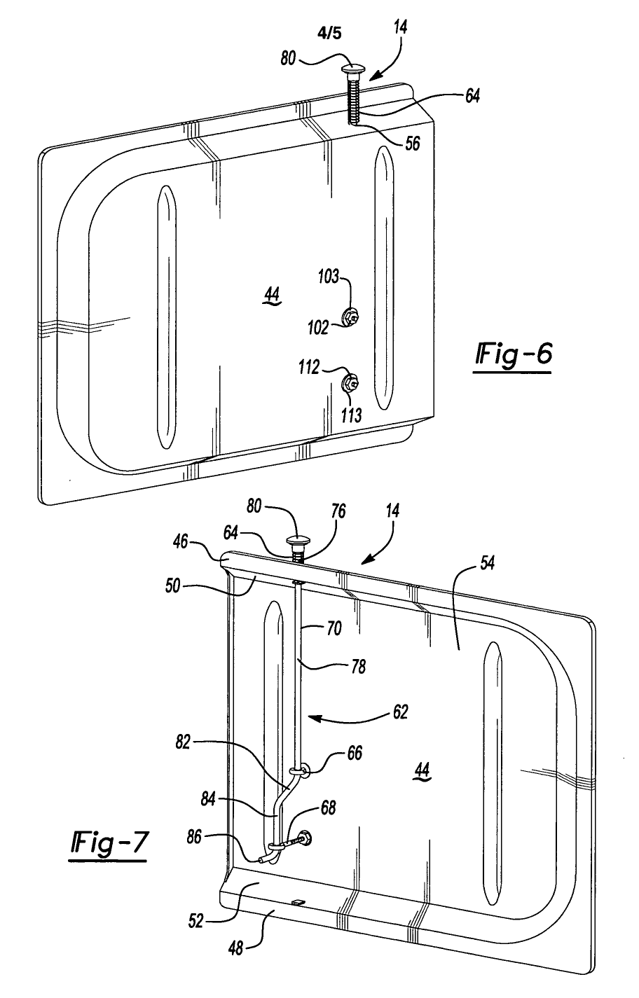

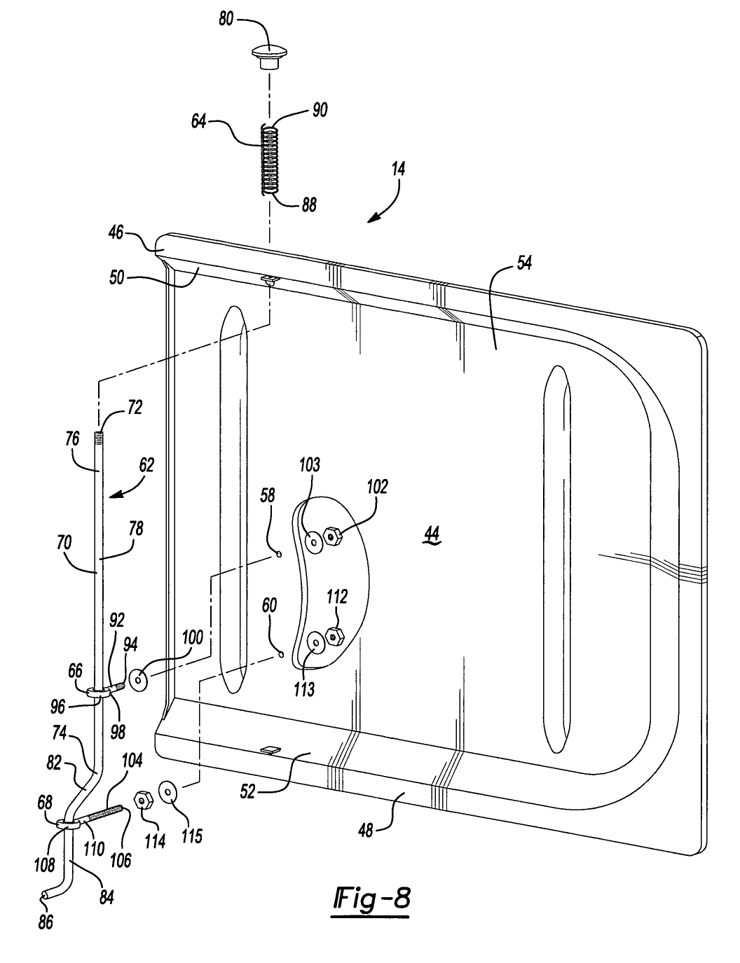

With additional reference to FIGS. 6-8, the housing 44 is generally rectangular and is sized to cover the first center section 38. The housing 44 includes upper and lower edge portions 46, 48 which slidably engage tracks 34, 36. Upper and lower walls 50, 52 extend from upper and lower edge portions 46, 48 to create a central recessed portion 54. The upper wall 50 includes an aperture 56 to house the door latch actuation assembly 14. The central recessed portion 54 includes a series of apertures 58, 60 to provide attachment points for portions of door latch actuation assembly 14, discussed in greater detail below.

The door latch actuation assembly 14 generally includes a latch actuation member 62, biasing member such as a coil spring 64 and a series of guide members 66, 68. The latch actuation member 62 is shown formed from a continuous metal rod. The latch actuation member 62 generally includes four portions. The first portion 70 extends through aperture 56 in upper wall 50 and includes first and second ends 72, 74. The first portion 70 is generally straight and extends generally parallel to door edges 20, 22. An upwardly extending portion 76, which includes the first end 72, is disposed above the upper wall 50 and generally forms an internal actuation portion. A downwardly extending portion 78, which includes the second end 74, is disposed below the upper wall 50.

The upwardly extending portion 76 is generally disposed on the interior portion 16 of the door 12. The downwardly extending portion 78 is generally disposed on the exterior portion 18 of the door 12. The first end 72 includes a knob 80. The knob 80 can be coupled to the latch actuation member 62 in a variety of ways, such as being screwed or press-fit onto the first end 72. The second portion 82 of the latch actuation member 62 is generally straight. The second portion 82 extends from the second end 74 of the first portion 70 generally outwardly from the central recessed portion 54 at an acute angle. The third portion 84 is also generally straight. The third portion 84 extends from the second portion 82 at an acute angle and is generally parallel to the first portion 70. The fourth portion 86 is likewise generally straight. The fourth portion 86 extends generally perpendicular from the third portion 84, to form an engagement portion.

The coil spring 64 is disposed about the circumference of the upwardly extending portion 76 of the first portion 70 of the latch actuation member 62. A lower portion 88 of the coil spring 64 engages the upper wall 50. An upper portion 90 of the coil spring 64 engages the knob 80 coupled to the first end 72 of the first portion 70 of the latch actuation member 62. Thus, the coil spring 64 biases between these two members to provide an upward force on the latch actuation member 62.

The series of guide members 66, 68 generally extend from the central recessed portion 54 of the door 12 in a direction toward the exterior portion 18 of the door 12. The first guide member 66 is disposed proximate the second end 74 of the first portion 70 of the latch actuation member 62. The cylindrical body portion 92 includes a thread on a first end 94 and a guide feature 96 formed on a second end 98. The guide feature 96 is generally in the form of an eyelet. The eyelet surrounds a circumferential portion of the first portion 70 of latch actuation member 62, to provide a slidable engagement. A washer 100 is disposed between the guide feature 96 and the outside of the central recessed portion 54. The first guide member 66 includes a generally cylindrical body portion 92, which passes through aperture 58 in the central recessed portion 54. An additional washer 103 is disposed between nut 102 and an inner side of central recessed portion 54. A nut 102 is threaded onto the first end 94 of the cylindrical body portion 92 on the inside of the central recessed portion 54. This couples the first guide member 66 to the central recessed portion 54.

The second guide member 68 includes a cylindrical body portion 104 generally similar to the first guide member 66. However, the second guide member 68 has a longer cylindrical body portion 104 to provide engagement between the second guide member 68 and the third body portion 84. A guide feature 108 is formed on a second end 110 of the cylindrical body portion 104. The guide feature 108 is generally in the form of an eyelet slidably coupled to the third portion 84 of the latch actuation member 62. The second guide member 68 is coupled to the central recessed portion 54 by a first nut 114. A washer 115 is disposed between nut 114 and the outer side of the central recessed portion 54. A first end 106 of cylindrical body portion 104 extends through aperture 60. An additional washer 113 is disposed between the second nut 112 and the inside of the central recessed portion 54. A second nut 112 is threaded on the cylindrical body portion 104 on the inside of the central recessed portion 54. This couples the second guide member 68 to the central recessed portion 54.

With reference to the operation of the door latch actuation assembly 14, the latch actuation member 62 is positioned above the radially extending portion 26 of handle 24 when the housing 44 is displaced the maximum distance toward the first edge 20 of the door 12 (as seen in FIGS. 1 and 2). When in this position, the handle 24 can be actuated from the inside of the motorhome/travel trailer 10 by applying a downward force to knob 80. The downward force on knob 80 translates the latch actuation member 62 axially downward, which in turn, forces the fourth portion 86 of the latch actuation member 62 to act on the radially extending portion 26 of handle 24. This causes the handle 24 to rotate, to enable the door 12 to be opened.

The latch actuation member 62 is held in position by spring 64, guides 66, 68 and aperture 56. The latch actuation member 62 is normally biased in an unengaged position (as seen in FIGS. 2-4) due to the spring 64, which applies an axially upward force on the knob 80 coupled to the latch actuation member 62. Guides 66, 68 and aperture 56 guide the travel of the latch actuation member 62 when the latch actuation member 62 is forced downward to an engaged position (as seen in FIG. 5). When the spring 64 returns to its resting unbiased position, which, in turn, returns the latch actuation member 62 to an unengaged position, the guides 66, 68 and aperture 56 guide travel to the unengaged position as well.

The guides 66, 68 also serve as travel limiters when the latch actuation member 62 is in an unengaged position. The second portion 82 of the latch actuation member 62 is prevented from passing through first guide 66 due to the angular extension. Similarly, the second guide 68 prevents the fourth portion 86 from passing through, since the fourth portion 86 is disposed at an angle relative to the third portion 84.

Travel is also limited when the latch actuation member 62 is moved to an engaged position. When the spring 64 is compressed a maximum distance, the latch actuation member 62 is prevented from further travel. Additionally, when the latch actuation member 62 is displaced a distance generally equal to the length of the third portion 84, the angled second portion 82 is unable to travel through guide 68. This limits the travel of the latch actuation member 62.

The guides 66, 68 further serve as rotation limiters. Since the guides 66, 68 are offset from one another, they substantially prevent rotation of the latch actuation member 62.

The description is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A door latch actuation assembly comprising:
a latch actuation member slidably coupled to a door, said latch actuation member including first and second portions, said first portion disposed on an interior of said door and including an internal actuation portion, said second portion including an engagement portion, said engagement portion configured to actuate an external actuation member, said external actuation member having a first portion coupled to an exterior of said door.

2. The door latch actuation assembly of claim 1, wherein said engagement portion is disposed on said exterior of said door proximate said first portion of said external actuation member, said engagement portion biasingly engaged with said external actuation member when in an engaged position.

3. The door latch actuation assembly of claim 2, wherein said engagement portion is biasingly engaged with an arm extending from said first portion of said external actuation member when in said engaged position, said first portion of said external actuation member being rotatably coupled to said door.

4. The door latch actuation assembly of claim 1, wherein said internal actuation portion generally extends from said interior of said door, said internal actuation portion slidably engaged with an aperture in said door.

5. The door latch actuation assembly of claim 1, wherein said latch actuation member includes a rigid body member disposed between and fixedly coupled to said internal actuation portion and said engagement portion.

6. The door latch actuation assembly of claim 1, further comprising a biasing member biasing said latch actuation member to an unengaged position.

7. The door latch actuation assembly of claim 6, wherein said biasing member is a coil spring.

8. A door assembly for a motorhome/travel trailer comprising:
a door having interior and exterior portions;
an exterior actuation assembly including an external actuation member having a first portion coupled to said exterior portion; and
a door latch actuation assembly including a latch actuation member slidably coupled to said door, said latch actuation member including first and second portions, said first portion disposed on said interior portion of said door and including an internal actuation portion, said second portion including an engagement portion, said engagement portion configured to actuate said external actuation member.

9. The door assembly of claim 8, wherein said door latch actuation assembly is coupled to a housing slidably coupled to said door.

10. The door assembly of claim 8, wherein said engagement portion is disposed on said exterior portion of said door proximate said first portion of said external actuation member, said engagement portion biasingly engaged with said external actuation member when in an engaged position.

11. The door assembly of claim 10, wherein said engagement portion is biasingly engaged with an arm extending from said first portion of said external actuation member when in said engaged position, said first portion of said external actuation member being rotatably coupled to said door.

12. The door assembly of claim 8, wherein said internal actuation portion generally extends from said interior portion of said door, said internal actuation portion slidably engaged with an aperture in said door.

13. The door assembly of claim 8, wherein said latch actuation member includes a rigid body member disposed between and fixedly coupled to said internal actuation portion and said engagement portion.

14. The door assembly of claim 8, further comprising a biasing member biasing said latch actuation member to an unengaged position.

15. The door assembly of claim 14, wherein said biasing member is a coil spring.

16. A motorhome/travel trailer comprising:
a body including an exterior and an interior with an opening therethrough; and
a door coupled to said body and covering said opening, said door having interior and exterior portions, said door including an exterior actuation assembly and a door latch actuation assembly, said exterior actuation assembly including an external actuation member having a first portion coupled to an exterior portion of said door, said door latch actuation assembly including a latch actuation member slidably coupled to said door, said latch actuation member including first and second portions, said first portion disposed on an interior portion of said door and including an internal actuation portion, said second portion including an engagement portion, said engagement portion configured to actuate said external actuation member.

17. The motorhome/travel trailer of claim 16, wherein said door includes an additional opening therethrough and a housing selectively covering said additional opening, said housing slidably coupled to said door.

18. The motorhome/travel trailer of claim 17, wherein said latch actuation member is coupled to said housing.

19. The motorhome/travel trailer of claim 18, wherein said housing is configured to remain slidably engaged with said door when said latch actuation member is coupled to said housing.

20. The motorhome/travel trailer of claim 16, wherein said engagement portion of said latch actuation member is disposed on said exterior of said door proximate said first portion of said external actuation member, said engagement portion biasingly engaged with said external actuation member when in an engaged position.

21. The motorhome/travel trailer of claim 16, wherein said internal actuation portion of said latch actuation member generally extends from said interior of said door, said internal actuation portion slidably engaged with an aperture in said door.
